(19) United States
(12) Patent Application Publication
(10) Pub. No.: US 2014/0289697 A1
(43) Pub. Date: Sep. 25, 2014

(54) Systems and Methods for Software Development

(71) Applicant: The Procter & Gamble Company, Cincinnati, OH (US)

(72) Inventors: Jan Wenda, Warsaw (PL); Adam Kaczmarek, Warszawa (PL)

(73) Assignee: The Procter & Gamble Company, Cincinnati, OH (US)

(21) Appl. No.: 14/194,839

(22) Filed: Mar. 3, 2014

Related U.S. Application Data
(60) Provisional application No. 61/803,909, filed on Mar. 21, 2013.

(51) Int. Cl. G06Q 10/06; G06F 9/44

(52) U.S. Cl. CPC G06Q 10/06; G06F 8/77
USPC 717/102

(57) ABSTRACT

Included are embodiments for providing a programming platform for a third party programmer. Some embodiments include providing a platform for the third party programmer to submit a computer program for an enterprise and analyzing the computer program to determine whether the computer program violates a rule that is uniform for a plurality of different computer programs for the enterprise. Some embodiments are configured to, in response to determining that the computer program violates the rule, provide a user interface that identifies an issue that causes the computer program to violate the rule and provide the third party programmer an opportunity to alter the computer program to address the issue.

### FIELD OF THE INVENTION

The present application relates generally to systems and methods for software development and specifically to systems and methods that allow third parties to create software that complies with predetermined standards of an organization.

### BACKGROUND OF THE INVENTION

Currently, many organizations contract with outside programmers or other third parties for creating new software for the organization. As this can be a mechanism for the organization to create new software, oftentimes different programmers create programs using different programming languages and the software quality may vary greatly. Accordingly, efficiencies and quality assurances may be difficult to achieve.

### SUMMARY

Included are embodiments for providing a programming platform for a third party programmer. Some embodiments include providing a platform for the third party programmer to submit a computer program for an enterprise and analyzing the computer program to determine whether the computer program violates a rule that is uniform for a plurality of different computer programs for the enterprise. Some embodiments are configured to, in response to determining that the computer program violates the rule, provide a user interface that identifies an issue that causes the computer program to violate the rule and provide the third party programmer an opportunity to alter the computer program to address the issue.

Additionally, embodiments include of a system include a memory component that stores logic that, when executed by a processor, causes the system to provide a platform for the third party programmer to submit a computer program for an enterprise and analyze the computer program to determine whether the computer program meets a quality threshold that is uniform for a plurality of different computer programs for the enterprise. In some embodiments, the logic causes the system to, in response to determining that the computer program does not meet the quality threshold, provide a user interface that identifies an issue that causes the computer program to not meet the quality threshold and provide the third party programmer an opportunity to alter the computer program to address the issue.

Some embodiments of a computing device include logic that, when executed by the computing device, causes the computing device to provide a platform for the third party programmer to submit a computer program for an enterprise, determine a rule that applies to a plurality of different computer programs utilized for the enterprise, and determine a quality threshold for the plurality of different computer programs, wherein the quality threshold is associated with the rule. In some embodiments, the logic causes the computing device to analyze the computer program to determine whether the computer program follows the rule and meets the quality threshold and, in response to determining that the computer program does not meet the quality threshold or does not follow the rule, provide a user interface that identifies an issue that causes the computer program to not meet the quality threshold and provide the third party programmer an opportunity to alter the computer program to address the issue.

### BRIEF DESCRIPTION OF THE DRAWINGS

It is to be understood that both the foregoing general description and the following detailed description describe various embodiments and are intended to provide an overview or framework for understanding the nature and character of the claimed subject matter. The accompanying drawings are included to provide a further understanding of the various embodiments, and are incorporated into and constitute a part of this specification. The drawings illustrate various embodiments described herein, and together with the description serve to explain the principles and operations of the claimed subject matter.

FIG. 1 depicts a computing environment for software development, according to embodiments disclosed herein;

FIG. 2 depicts components of a verification computing device to facilitate the software development, according to embodiments disclosed herein;

FIG. 3 depicts a user interface that may be provided to a programmer for facilitating software development, according to embodiments disclosed herein;

FIG. 4 depicts a user interface that a programmer and/or administrator may receive for providing continuous inspection of a computer program, according to embodiments disclosed herein;

FIG. 5 depicts user interface that a programmer and/or administrator may receive for providing quality control of a computer program, according to embodiments disclosed herein;

FIG. 6 depicts a user interface for providing continuous integration of a computer program, according to embodiments disclosed herein;

FIG. 7 depicts a user interface for providing SQALE data for a program, according to embodiments disclosed herein;

FIG. 8 depicts a flowchart for verifying quality of program code, according to embodiments disclosed herein;

FIG. 9 depicts a flowchart for determining errors in program code, according to embodiments disclosed herein; and

FIG. 10 depicts a flowchart for determining whether a computer program violates a predetermined error, according to embodiments disclosed herein.

### DETAILED DESCRIPTION OF THE INVENTION

Embodiments disclosed herein include systems and methods for software development. Specifically, embodiments may be configured to facilitate the efficient programming of computer programs by third party programmers, while providing a platform for the third party programmers and/or the administrator to easily determine quality of the programs and create uniformity in programs across different programmers. Specifically, a computer programmer may receive and/or have access to framework logic, which provides a construct for the programmer to view the organization's criteria or at least one rule that the organization has identified as necessary for high quality computer programs. Accordingly, the programmer may be provided with options for creating the computer program, submitting the computer program, and otherwise adhering to the organization's criteria when creating the computer program. Upon submitting the computer program to a verification computing device, the verification computing device may analyze the computer program according to the organization's criteria and/or rules and may provide other options that provide the analysis to allow the computer programmer to revise the computer program. The computer programmer may resubmit the revised computer program for analysis. An administrator may be provided with a view to the progress and quality of the computer program.

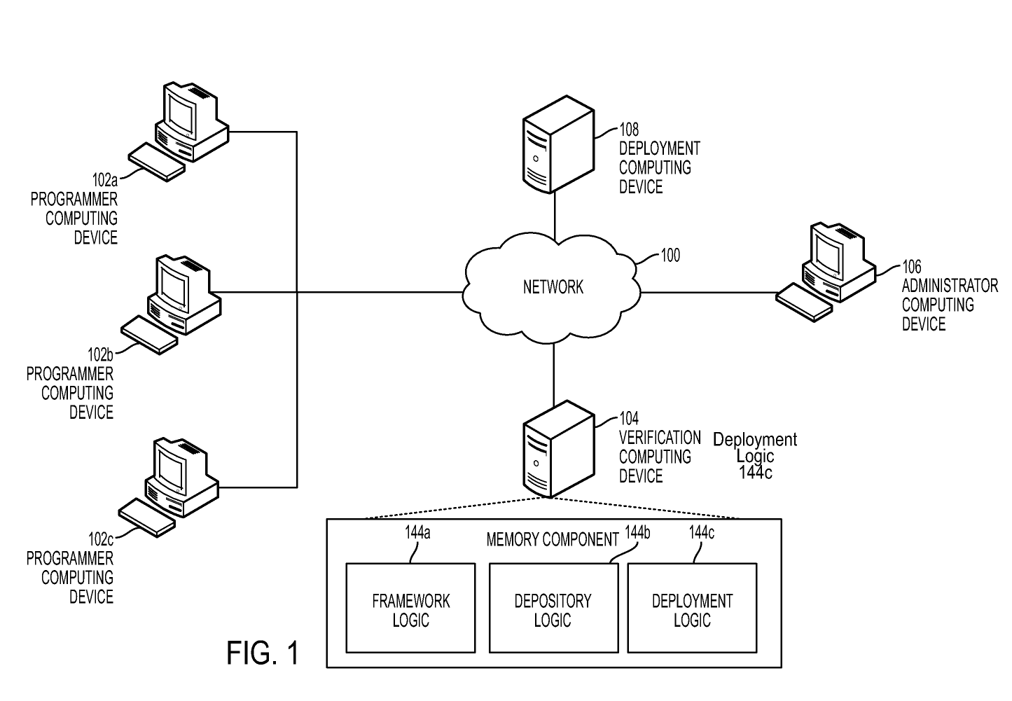

Referring now to the drawings, FIG. 1 depicts a computing environment for software development, according to embodiments disclosed herein. As illustrated, the computing environment may include a network 100, which may include a wide area network (wired or wireless), such as the internet, a cellular network, or other communications network for communicating devices across a wide area. Additionally, the network 100 may include a wired or wireless local area network for communicating data, as described herein.

Coupled to the network 100 are one or more programmer computing devices 102a, 102b, 102c (collectively referred to as “programmer computing devices 102”). The programmer computing devices 102 may be configured for discrete computer programmers to create computer programs and submit those computer programs to the verification computing device 104. As discussed in more detail below, the programmer computing devices 102 may additionally interface with the verification computing device 104 to receive criteria for the computer program, as well as view an assessment of at least one feature of the computer program to determine the quality of the computer program.

The verification computing device 104 may include a memory component 140 that stores framework logic 144a, depository logic 144b, and deployment logic 144c. The framework logic 144a may include one or more components, such as a web application framework component, an integration layer component, and an application creation component for facilitating creation of the computer program. The depository logic 144b may be configured to cause the verification computing device 104 to receive a computer program from the programmer computing devices 102 and determine the quality of the programming, as described below. The deployment logic 144c may cause the verification computing device 104 to deploy the computer program to the deployment computing device 108 for execution, after the computer program has been approved by an administrator or the administrator computing device 106.

The administrator computing device 106 may be configured for interfacing with the verification computing device 104 to view that analysis of computer programs from any of the programmer computing devices 102. The administrator computing device 106 may additionally facilitate communicating instructions to a computer programmer, and/or requesting additional computer programmers to create a computer program. Other administrative functions may also be performed via the administrator computing device 106.

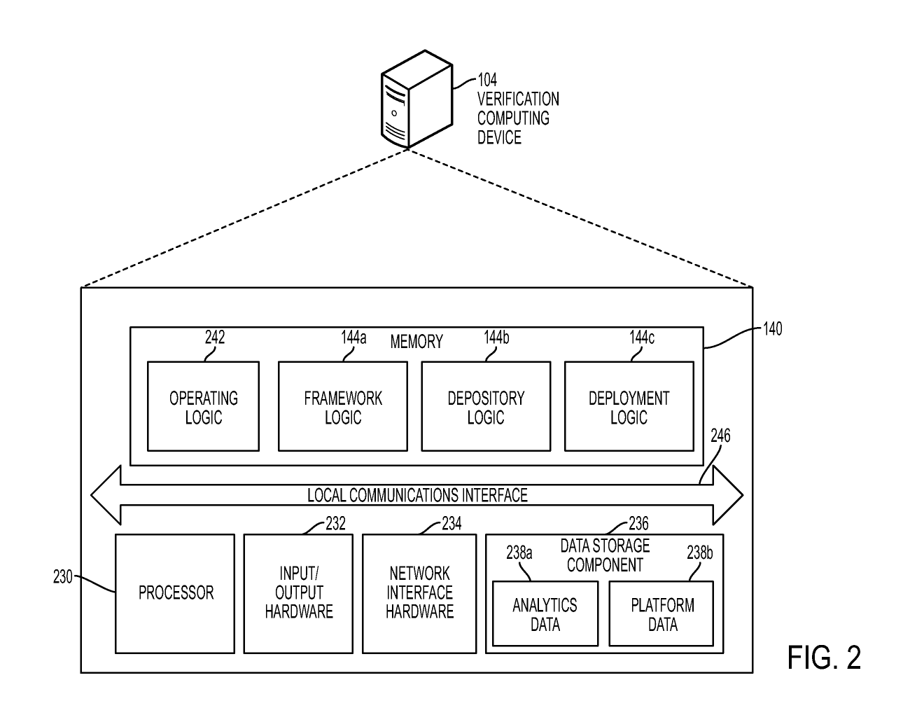

FIG. 2 depicts components of a verification computing device 104 to facilitate the software development, according to embodiments disclosed herein. As illustrated, the verification computing device 104 includes a processor 230, input/output hardware 232, a network interface hardware 234, a data storage component 236 (which stores analytics data 238a, platform data 238b, and/or other data), and a memory component 140. The memory component 140 may be configured as volatile and/or nonvolatile memory and as such, may include random access memory (including SRAM, DRAM, and/or other types of RAM), flash memory, secure digital (SD) memory, registers, compact discs (CD), digital versatile discs (DVD), and/or other types of non-transitory computer-readable mediums. Depending on the particular embodiment, these non-transitory computer-readable mediums may reside within the verification computing device 104 and/or external to the verification computing device 104.

The memory component 140 may store operating logic 242, the framework logic 144a, the depository logic 144b, and the deployment logic 144c. Each of these logic components may include a plurality of different pieces of logic, each of which may be embodied as a computer program, firmware, and/or hardware, as an example. A local interface 246 is also included in FIG. 2 and may be implemented as a bus or other communication interface to facilitate communication among the components of the verification computing device 104.

The processor 230 may include any processing component operable to receive and execute instructions (such as from a data storage component 236 and/or the memory component 134). As described above, the input/output hardware 232 may include and/or be configured to interface with the components of FIG. 2.

The network interface hardware 234 may include and/or be configured for communicating with any wired or wireless networking hardware, including an antenna, a modem, a LAN port, wireless fidelity (Wi-Fi) card, WiMax card, mobile communications hardware, and/or other hardware for communicating with other networks and/or devices. From this connection, communication may be facilitated between the verification computing device 104 and other computing devices.

The operating logic 242 may include an operating system and/or other software for managing components of the verification computing device 104. Similarly, as discussed above, the framework logic 144a may reside in the memory component 140 and may be configured to cause the processor 230 to provide a framework for programming and analyzing received computer programs. The depository logic 144b may be configured to cause the memory component 140 to cause the processor 230 to receive computer programs from the programmer computing devices 102 and perform the analysis of those computer programs. The deployment logic 144c may cause the processor 230 to facilitate communication with the deployment computing device 108 for deploying approved computer programs into the organizations computer infrastructure.

It should be understood that while the components in FIG. 2 are illustrated as residing within the verification computing device 104, this is merely an example. In some embodiments, one or more of the components may reside external to the verification computing device 104 or within other devices, such as those depicted in FIG. 1. It should also be understood that, while the verification computing device 104 is illustrated as a single device, this is also merely an example. In some embodiments, the framework logic 144a, the depository logic 144b, and the deployment logic 144c may reside on different computing devices. As an example, one or more of the functionalities and/or components described herein may be provided by the programmer computing devices 102, the administrator computing device 106, and/or the deployment computing device 108.

Additionally, while the verification computing device 104 is illustrated with the framework logic 144a, the depository logic 144b, and the deployment logic 144c as separate logical components, this is also an example. In some embodiments, a single piece of logic may provide the described functionality.

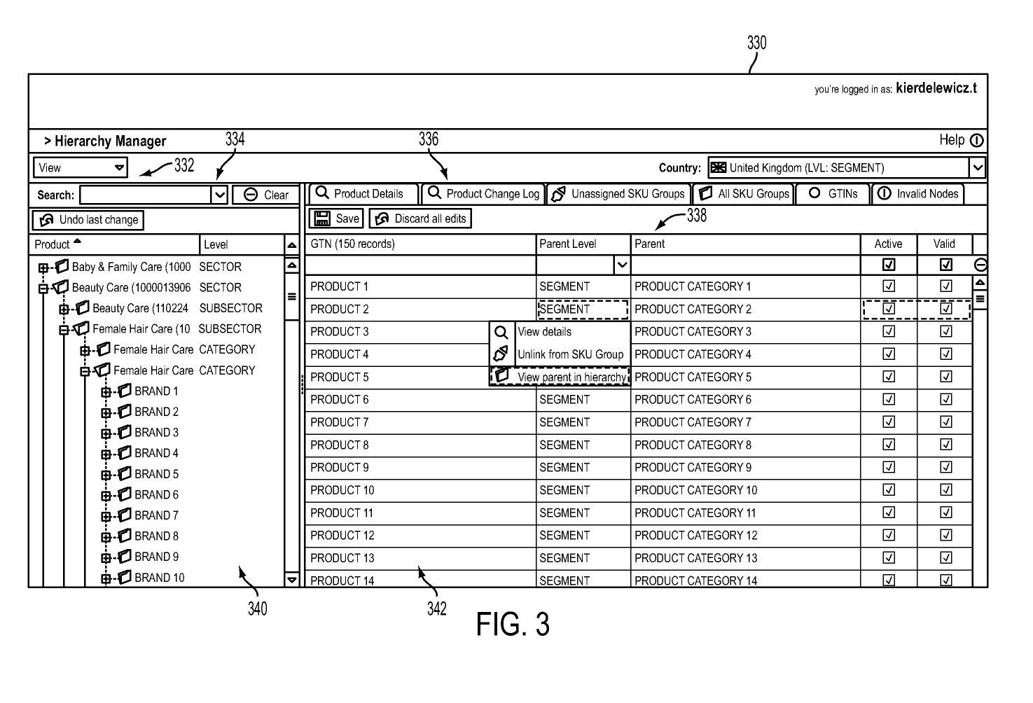

FIG. 3 depicts a user interface 330 that may be provided to a programmer for facilitating software development, according to embodiments disclosed herein. As illustrated, the user interface 330 may provide a hierarchy manager for an administrator to view received programs, as well as the compliance with enterprise standards. As an example, the user interface 330 includes menu option 332 for providing sub-options such as view, create, edit, and delete. As an example, if the administrator wishes to create a new project for receiving one or more computer programs, the administrator may select a create sub-option in the menu option 332. Similarly, the edit sub-option may allow the administrator to edit the hierarchy depicted in the user interface 330 and/or otherwise edit the content therein. The delete sub-options provides the ability to delete one or more of the hierarchy elements. The view sub-option is selected in FIG. 3 and provides a search option 334, as well as a plurality of tab options 336, such as product details, product change log, unassigned stock keeping unit (SKU) groups, global trade item numbers (GTINs), and invalid nodes. The product details tab provide detailed information regarding a selected product depicted in the hierarchy section 340 and/or from the product listing section 342. The product change log tab may be selected to change the information regarding a selected product. The SKU groups tab may provide information on SKUs and the products associated with the SKUs. Similarly, the GTINs tab may provide GTIN information related to the provided products. The invalid nodes tab provides nodes in the hierarchy that are not valid.

Additionally, the product listing section 342 may include columns 338, such as a GTIN column, a parent level column, a parent column, and active column and a valid column. The product listing section 342 may provide a listing of products associated with a selected brand. The parent level column may identify a parent level of the associated product. The parent column may identify a category of the product. The active column may indentify whether the product is currently active. The valid column identities whether the product is a valid node.

It should be understood that the user interface 330 may be utilized for an administrator to set up a platform for a computer programmer to create computer programs associated with one or more products. Additionally, the administrator may specifically commission projects to be sent to programmers for creating new computer programs, as described in more detail below.

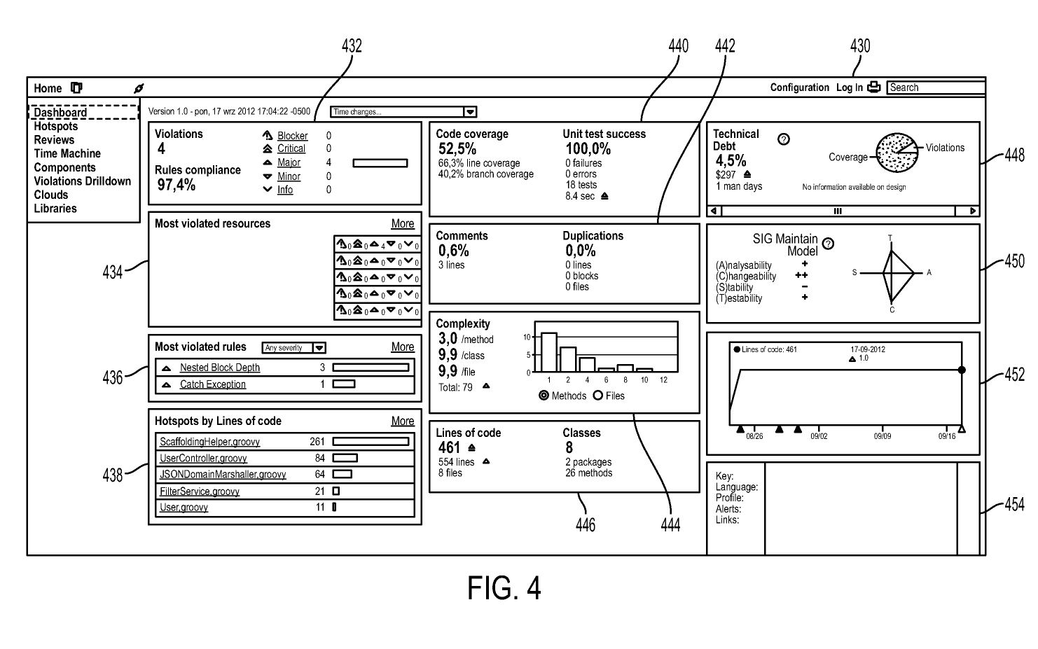

FIG. 4 depicts a user interface 430 that a programmer and/or administrator may receive for providing continuous inspection of a computer program, according to embodiments disclosed herein. Specifically, embodiments described herein may allow an administrator to inspect the quality of a new computer program that may be utilized by the enterprise or organization. In so doing, the enterprise computing infrastructure (such as depicted in FIG. 1) may be configured to provide the programmer computing device 102 with information and/or a user interface for creating the computer program. The information may include at least one quality threshold that is associated with the rule for determining whether a submitted computer program may be utilized or whether the submitted computer program needs editing. From this information, the computer programmer may create the computer program and may then submit the created computer program to the verification computing device 104 to determine the quality of the computer program, based on the rule and/or quality threshold. After running one or more test sequences on the computer program, the verification computing device 104 may determine one or more errors or other issues in the computer program. Accordingly, at least a portion of this information may be provided by the user interface 430 of FIG. 4.

As illustrated, the user interface 430 includes data related to a computer program that was written by a third party computer programmer, such as on the programmer computing device 102a. Specifically, the user interface 430 includes a rules compliance section 432, a violation section 434, a violated rules section 436, a hotspot section 438, a code coverage section 440, a comments section 442, a complexity section 444, a lines section 446, a technical debt section 448, a model section 450, a line graph section 452, and a data section 454.

The rules compliance section 432 provides information regarding whether the computer program violates any rules and/or quality thresholds as set by the platform. As discussed above, an administrator or other personnel may set criteria for this particular computer program and/or for all computer programs that are created by third party programmers. These criteria may be input into the verification computing device 104. As an example, the administrator may set a rule that all computer programs must contain at embedded comments on more than 40% of all code. The administrator may then set a quality threshold, such that if a computer program has comments on 40% of the code, a violation may occur, but that violation may be identified as a minor issue. If a computer program has comments on 39% of the code, a threshold may be set as a major issue. Regardless, the computer program received from the third party programmer may be run and/or tested against the rules and criteria. From this testing, the verification computing device 104 may identify which rules and/or quality thresholds have been broken, as well as other information.

Additionally, the rules compliance section 432 includes a rules compliance percentage, which the administrator may use to determine the usability and value of the received computer program. The user interface 430 may provide the number of lines and/or modules that have issues, as well as the classification of the issue, based on a quality threshold. Specifically depicted in the user interface are a blocker issue, a critical issue, a major issue, a minor issue, and an informational issue.

Similarly, the violation section 434 provides a list of the most violated resources in the computer program. As an example, if a particular computer module has several issues, this provides information to the programmer and/or administrator to best address the issues. The violated rules section 436 provides a listing of the at least one rule that is violated by most computer programs that are analyzed. As discussed above, the administrator may designate one or more rules for programs received by the enterprise. Accordingly, the rules that have been violated by the received computer program may be listed in this section.

The hotspot section 438 provides resources that are most likely to be used for particular lines of code. The code coverage section 440 provides percentage coverage data related to code and unit test success. The comments section 442 provides information related to the number of comments included in the computer program. The complexity section 444 provides information related to the complexity of the computer program. The lines section 446 provides information related to the number of lines and classes in the computer program. The technical debt section 448 provides information related to a comparison of violations verses coverage. The model section 450 provides information related to analyzability, changeability, stability, and testability. The line graph section 452 provides a graphical depiction related to the number of lines of code.

The data section 454 provides information related to the computer program.

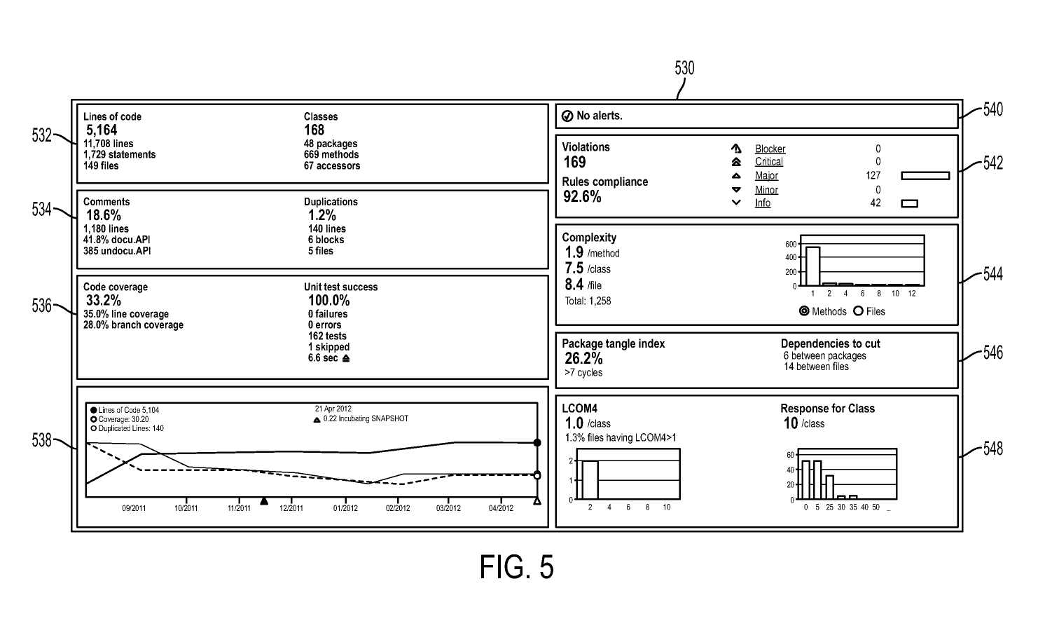

FIG. 5 depicts another user interface 530 that a programmer and/or administrator may receive for providing quality control of a computer program, according to embodiments disclosed herein. As illustrated, the user interface 530 provides a lines section 532, a comments section 534, a code coverage section 536, a graphical section 538, an alerts section 540, a violations section 542, a complexity section 544, a package tangle index section 546, and a response section 548.

The lines section 532, the comments section 534, and the code coverage section 536 may be configured to provide various textual statistics regarding the computer program. The graphical section 538 may compile the textual statistics from the lines section 532, the comments section 534, and/or the code coverage section 536 to provide a graphical representation over time. The alerts section 540 may identify whether the computer program currently has any alerts. The violations section 542 may provide information related to the issues and/or errors, similar to the rules compliance section 432 from FIG. 4. The complexity section 544 may provide various complexity statistics related to methods, files, classes, and/or other portions of the computer program. The package tangle index section 546 may provide information on dependencies in the computer program. The response section 548 may provide statistics regarding response per class.

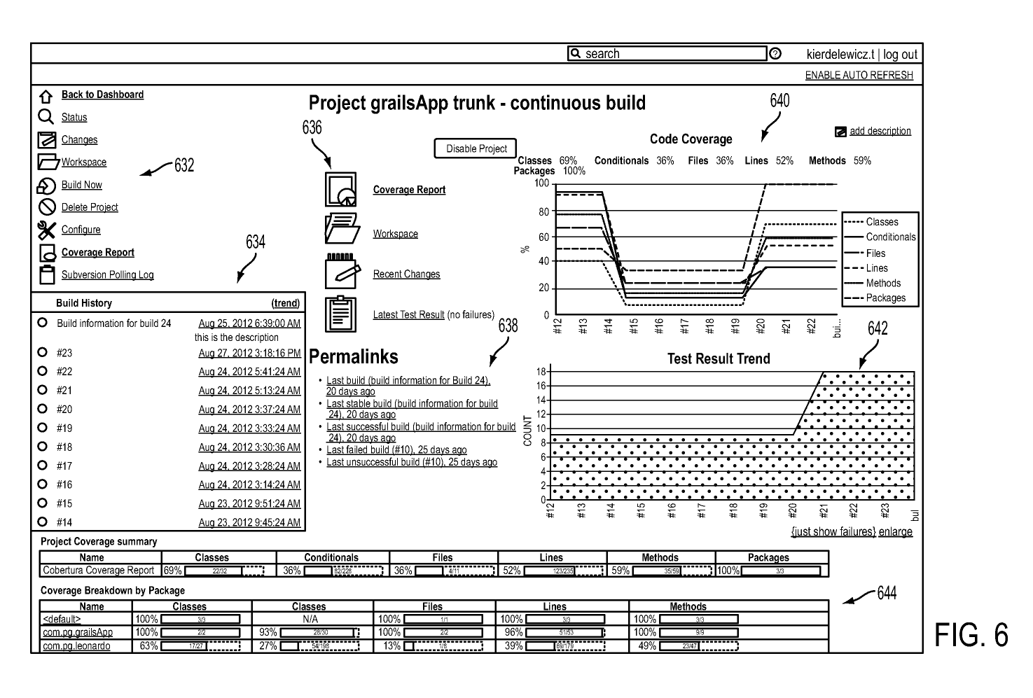

FIG. 6 depicts a user interface 630 for providing continuous integration of a computer program, according to embodiments disclosed herein. As illustrated, the user interface 630 includes an actions section 632, a build history section 634, a monitor section 636, a links section 638, a code coverage section 640, a test result trend section 642, and a project coverage summary section 644.

Specifically, the actions section 632 includes a status option, a changes option, a workspace option, a build now option, a delete project option, a configure option, a coverage report option, and a subversion polling log option. In response to selection of the status option, a current status of the computer program may be provided. In response to selection of the changes option, a listing of previous changes may be provided, as well as options to make additional changes. In response to selection of the workspace option, a workspace associated with the computer program may be provided. In response to selection of the build now option, the computer program may be run for testing. In response to selection of the delete project option, the project and/or computer program may be deleted. In response to selection of the configure option, one or more configuration options may be provided. In response to selection of the coverage report option, the coverage report may be provided. In response to selection of the subversion polling log option, the subversion polling log may be provided.

Also included is the build history section 634, which includes a listing of builds that have been created for the computer program. The monitor section 636 provides a coverage report option, a workspace option, a recent changes option, and a test result option. The links section 638 provides links for last builds of the computer program. The code coverage section 640 provides a data representation and a graphical representation of classes, conditionals, files, lines, methods, and packages for the project and/or computer program. The test result trend section 642 may provide test results for various builds.

Additionally, the project coverage summary section 644 may provide coverage statistics for classes conditionals, files, lines, methods, and packages for various packages in the project. This information may be helpful to the administrator and/or programmer in assessing the quality of the project.

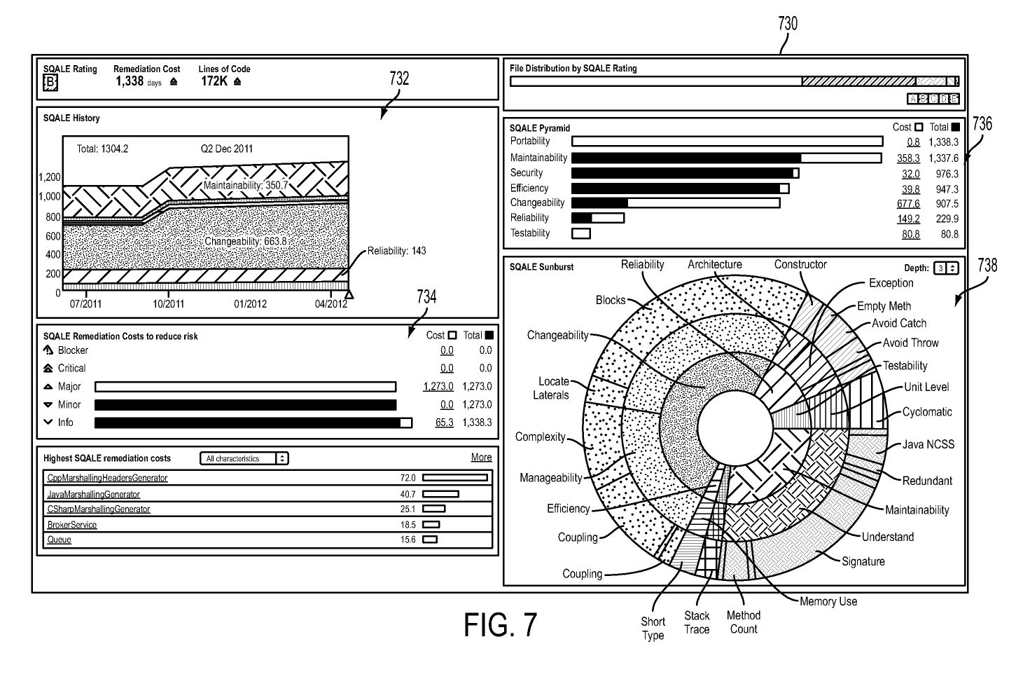

FIG. 7 depicts a user interface 730 for providing software quality assessment based on lifecycle expectations (SQALE) data for a program, according to embodiments disclosed herein. As illustrated, the user interface 730 includes a SQALE history section 732, a SQALE remediation costs section 734, a SQALE pyramid section 736, and a SQALE sunburst section 738 The SQALE history section 732 includes a SQALE rating, a remediation cost, and a number of lines of code in a particular computer program. Also included is a graphical representation of various data associated with portability, maintainability, security efficiency, changeability, reliability, testability, etc. This data may provide a view over time of the number of lines of code that adhere to various quality parameters of the SQALE assessment. Depending on the particular embodiment, at least one predetermined quality threshold for one or more of these parameters may be provided. Thus, the quality threshold may be associated with one or more administrator-defined rule. The rule and/or threshold may be defined for all computer programs that are received to ensure quality for all of these computer programs. If a particular computer program does not meet one or more of these thresholds, the computer program may be sent back to the programmer to review and revise.

Additionally, the SQALE remediation costs section 734 may provide the assessed errors and/or warnings that are currently found in the computer program, as well as a rating of those issues. As an example, the issues may be classified as a blocker issue, a critical issue, a major issue, a minor issue, and an informational issue. Other classifications may be used, depending on the embodiment. Costs and totals associated with each of these types of issues may also be provided. As an example, a determination may be made regarding a threshold number (and/or cost) of blocker issues, a threshold number (and/or cost) of critical issues, a threshold number (and/or cost) of major issues, and a threshold number (and/or cost) of minor issues, and/or a threshold number of informational issues. Based on the number (and/or cost) of issues relative to the threshold, the computer program may be returned to the programmer for addressing the issues. Also included in the SQALE remediation costs section 734 is a list of remediation costs. The list of remediation costs may include one or more modules or components and the costs associated with those modules. Other characteristics may be depicted as well.

In the SQALE pyramid section 736 are a file distribution by SQALE rating, as well as a SQALE pyramid. The rating may be utilized to rate various components of the computer program in terms of one or more criteria to visually depict the quantity or cost of issues in the computer program. Similarly, the SQALE pyramid provides a visual depiction of the criteria depicted in the SQALE history section 732, such as portability, maintainability, security, efficiency, changeability, reliability, and testability. Each of these factors may have a cost associated therewith, which may be provided as well.

In the SQALE sunburst section 738, the computer program is broken into one or more sub-sections that indicate which portions of the computer program have requisite parameters, as described above. As an example, a determination may be made regarding whether a particular portion of the computer program has portability, maintainability, security efficiency, changeability, reliability, testability, etc. Based on a color coding and/or other visual depiction, this information regarding the quality of the computer program may be provided.

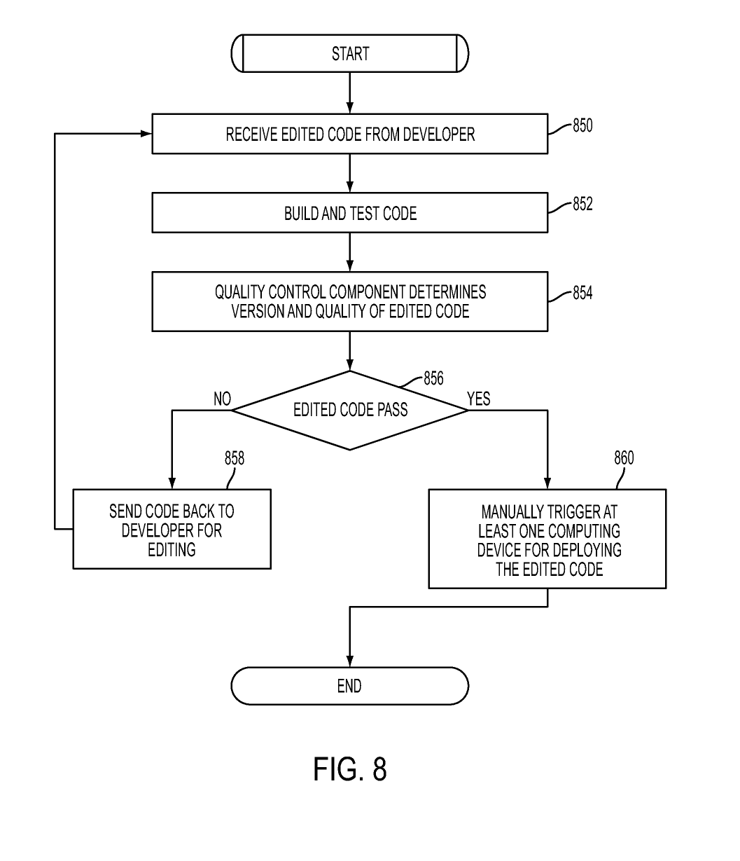

FIG. 8 depicts a flowchart for verifying quality of program code, according to embodiments disclosed herein. As illustrated in block 850, edited code may be received from a programmer and/or developer. Edited code may imply that the code was created and/or altered via one or more revisions. Regardless, in block 852, the code may be built and tested. By building and testing the code, embodiments disclosed herein may compile and/or otherwise execute the code in a testing mode to determine whether the code operates properly, according to predestined criteria. In block 854, a quality control component may determine version and quality of the edited code. In block 856, a determination is made regarding whether the edited code passes predetermined criteria, such as those described above. If the code does not pass, the code may be sent back to the programmer and/or developer, as depicted in block 858. If the code passes, embodiments may trigger at least one computing device for deploying the edited code, as depicted in 860.

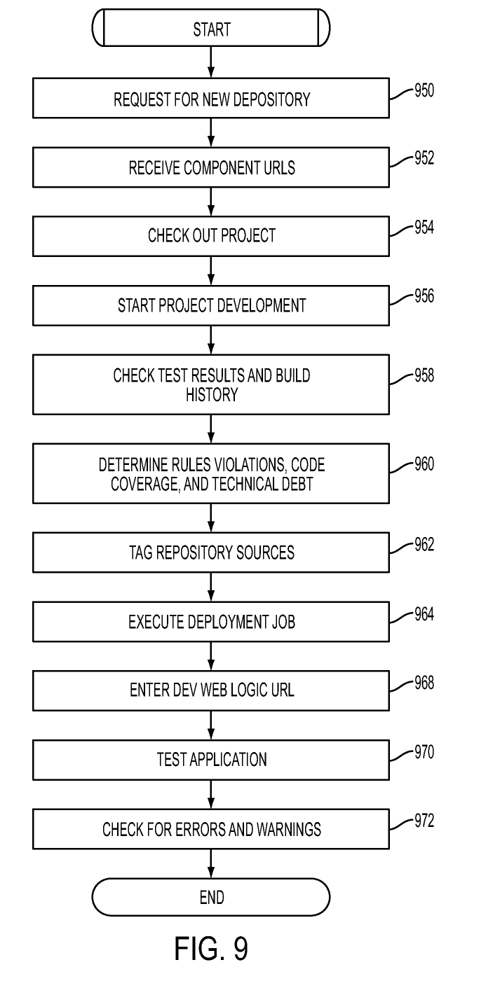

FIG. 9 depicts a flowchart for determining errors in program code, according to embodiments disclosed herein. As illustrated in block 950, a request for a depository may be provided. In block 952, component uniform resource locators (URLs) may be received. In block 954, the project may be checked out. In block 956, project development may be started. In block 958, the test results and build history of the project (and associated computer program) may be checked. In block 960, rules violations, code coverage, and technical debt may be determined. In block 962, repository sources may be tagged. In block 964, a deployment job may be executed. In block 968, a development web logic URL may be entered. In block 970, the application may be tested. In block 972, the application may be checked for errors and warnings.

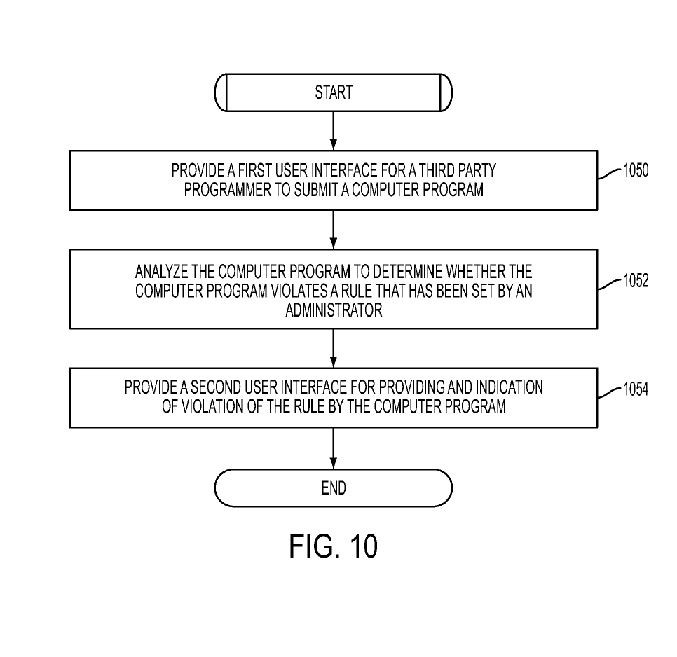

FIG. 10 depicts a flowchart for determining whether a computer program violates a predetermined error, according to embodiments disclosed herein. In block 1050, a first user interface for a third party programmer to submit a computer program may be provided. In block 1052, the computer program may be analyzed to determine whether the computer program violates a rule that has been set by an administrator. In block 1054, a second user interface may be provided for providing an indication of violation of the rule by the computer program.

Additionally, embodiments disclosed herein may provide options and/or functionality or providing updates and patches to an implemented program or project. As an example, a team may monitor a component for new patches. At least one downloaded file may be scanned using antivirus software and MD5 checksums may be double checked. Patches may then be installed and verified on a test environment. Verified patches may be stored for regular updates and/or immediately. With regard to updates, the tem may monitor the system for upgrades and selectively decide if the upgraded version will be included I the system. If so, implementing system platform upgrades may be performed and the new components may be double-checked for free and open source software (FOSS) compliance.

Further, embodiments described herein may utilize one or more existing software, depending on the particular configuration. Examples of such software may include SmartClent, Grails, Groovy, SVN, Jenkins, Sonar, WebLogic, Maven, Ant, PostgreSQL, Java SDK, and Nexus.

The dimensions and values disclosed herein are not to be understood as being strictly limited to the exact numerical values recited. Instead, unless otherwise specified, each such dimension is intended to mean both the recited value and a functionally equivalent range surrounding that value. For example, a dimension disclosed as “40 mm” is intended to mean “about 40 mm.”

Every document cited herein, including any cross referenced or related patent or application and any patent application or patent to which this application claims priority or benefit thereof, is hereby incorporated herein by reference in its entirety unless expressly excluded or otherwise limited. The citation of any document is not an admission that it is prior art with respect to any invention disclosed or claimed herein or that it alone, or in any combination with any other reference or references, teaches, suggests or discloses any such invention. Further, to the extent that any meaning or definition of a term in this document conflicts with any meaning or definition of the same term in a document incorporated by reference, the meaning or definition assigned to that term in this document shall govern.

While particular embodiments of the present invention have been illustrated and described, it would be understood to those skilled in the art that various other changes and modifications can be made without departing from the spirit and scope of the invention. It is therefore intended to cover in the appended claims all such changes and modifications that are within the scope of this invention.

What is claimed is:

1. A system for providing a programming platform for a third party programmer comprising:
a memory component that stores logic that, when executed by a processor, causes the system to perform at least the following:
provide a platform for the third party programmer to submit a computer program for an enterprise;
analyze the computer program to determine whether the computer program meets a quality threshold that is uniform for a plurality of different computer programs for the enterprise; and
in response to determining that the computer program does not meet the quality threshold, provide a user interface that identifies an issue that causes the computer program to not meet the quality threshold and provide the third party programmer an opportunity to alter the computer program to address the issue.

2. The system of claim 1, wherein the logic further causes the system to perform the following:
receive a revised computer program from the third party programmer;
analyze the revised computer program to determine whether the revised computer program meets the quality threshold; and
in response to determining that the revised computer program meets the quality threshold, deploy the revised computer program.

3. The system of claim 1, wherein the user interface is additionally provided to an administrator.

4. The system of claim 1, wherein the logic further causes the system to determine whether the issue is one of the following: a blocker issue, a critical issue, a major issue, a minor issue, and an informational issue.

5. The system of claim 1, wherein the quality threshold includes at least one rule that is configurable by an administrator.

6. The system of claim 1, wherein the system comprises a deployment computing device, an administrator computing device, and a verification computing device.

7. The system of claim 1, wherein the logic further causes the system to determine software quality assessment based on lifecycle expectations (SQALE) associated with the computer program and provide at least one statistic associated with the SQALE.

8. A method for providing a programming platform for a third party programmer, comprising:
providing, by a computing device, a platform for the third party programmer to submit a computer program for an enterprise;
analyzing, by the computing device, the computer program to determine whether the computer program violates a rule that is uniform for a plurality of different computer programs for the enterprise; and
in response to determining that the computer program violates the rule, providing, by the computing device, a user interface that identifies an issue that causes the computer program to violate the rule and provide the third party programmer an opportunity to alter the computer program to address the issue.

9. The method of claim 8, further comprising:
receiving a revised computer program from the third party programmer;
analyzing the revised computer program to determine whether the revised computer program follows the rule; and
in response to determining that the revised computer program follows the rule, deploying the revised computer program.

10. The method of claim 8, wherein the user interface is additionally provided to an administrator.

11. The method of claim 8, further comprising determining whether the computer program meets a quality threshold, wherein the quality threshold is associated with the rule.

12. The method of claim 11, further comprising, in response to determining that the computer program meets the quality threshold, deploying the computer program.

13. The method of claim 8, wherein the rule is configurable by an administrator.

14. The method of claim 8, determine software quality assessment based on lifecycle expectations (SQALE) associated with the computer program and provide at least one statistic associated with the SQALE.

15. A computing device for providing a programming platform for a third party programmer comprising:
a processor; and
a memory component that stores logic that, when executed by the processor, causes the computing device to perform the following:
provide a platform for the third party programmer to submit a computer program for an enterprise;
determine a rule that applies to a plurality of different computer programs utilized for the enterprise;
determine a quality threshold for the plurality of different computer programs, wherein the quality threshold is associated with the rule;
analyze the computer program to determine whether the computer program follows the rule and meets the quality threshold; and
in response to determining that the computer program does not meet the quality threshold or does not follow the rule, provide a user interface that identifies an issue that causes the computer program to not meet the quality threshold and provide the third party programmer an opportunity to alter the computer program to address the issue.

16. The computing device of claim 15, wherein the logic further causes the computing device to perform the following:
receive a revised computer program from the third party programmer;
analyze the revised computer program to determine whether the revised computer program meets the quality threshold and follows the rule; and
in response to determining that the revised computer program meets the quality threshold and follows the rule, deploy the revised computer program.

17. The computing device of claim 15, wherein the user interface is additionally provided to an administrator.

18. The computing device of claim 15, wherein the logic further causes the computing device to determine whether the issue is one of the following: a blocker issue, a critical issue, a major issue, a minor issue, and an informational issue.

19. The computing device of claim 15, wherein the quality threshold and the rule are configurable by an administrator.

20. The computing device of claim 15, wherein the logic is executed by at least one of the following: a programmer computing device, a verification computing device, and a deployment computing device.
